(19) United States
(12) Patent Application Publication
(10) Pub. No.: US 2008/0307858 A1
(43) Pub. Date: Dec. 18, 2008

(54) Apparatus and Process for Leak-Testing and Qualification of Fluid Dispensing Vessels

(75) Inventors: James V. McManus, Bethel, CT (US); Stuart Muller, Rowley, MA (US); Ryan Clement, Burlington, MA (US)

Correspondence Address: INTELLECTUAL PROPERTY / TECHNOLOGY LAW, PO BOX 14329, RESEARCH TRIANGLE PARK, NC, 27709, US

(73) Assignees: ADVANCED TECHNOLOGY MATERIALS, INC., Danbury, CT (US); MATHESON TRI-GAS, INC., Longmont, CO (US)

(21) Appl. No.: 11/817,226

(22) PCT Filed: Feb. 28, 2006
(86) PCT No.: PCT/US06/07027

§ 371 Date: Aug. 14, 2008

Related U.S. Application Data
(60) Provisional application No. 60/657,027, filed on Feb. 28, 2005.
(60) Provisional application No. 60/657,028, filed on Feb. 28, 2005.
(60) Provisional application No. 60/660,733, filed on Mar. 11, 2005.

(51) Int. Cl. G01M 3/04; G01D 18/00

(52) U.S. Cl. 73/40.7; 73/1.01

(57) ABSTRACT

A system (10) for leak-testing an article (20) required to be fluid leak-tight in use at a fluid contacting region (38) thereof, to determine fluid leakage through the article to a non-fluid contacting region (40) of the article. The system includes a leak-testing fluid held in confinement by the fluid-contacting region of the article, a vacuum assembly (46, 66) arranged for establishing a vacuum environment at the non-fluid-contacting region of the article, and a leak detector (76) arranged to detect presence or absence of the leak-testing fluid in the vacuum environment, to determine fluid leakage through the article. The system enables leak sensitivity significantly below 1×10⁻⁶ standard atmospheric-cc/scc to be achieved, e.g., sensitivity in a range of from 1×10⁻⁷ to 1×10⁻¹¹ standard atmospheric-cc/see, and is useful for quality assurance testing of vessels (118) intended to carry hazardous gases.

### CROSS REFERENCE TO RELATED APPLICATIONS

The present application is based on U.S. Provisional Patent Application No. 60/660,733 filed Mar. 11, 2005 in the names of James V. McManus, Stuart Muller and Ryan Clement entitled “Apparatus and Process for Leak-Testing and Qualification of Fluid Dispensing Vessels”; U.S. Provisional Patent Application No. 60/657,028 filed Feb. 28, 2005 in the name of James V. McManus entitled, “Apparatus and Process for Leak-Testing and Qualification of Fluid Dispensing Vessels”; and U.S. Provisional Patent Application No. 60/657,027 filed Feb. 28, 2005 in the names of Stuart Muller and Ryan Clement entitled, “Apparatus and Process for Leak-Testing and Qualification of Fluid Dispensing Vessels”.

### FIELD OF THE INVENTION

The present invention relates to apparatus and process for leak-testing and qualification of fluid dispensing vessels.

### DESCRIPTION OF THE RELATED ART

In the use of packaged gases, conventional practice in many industrial applications has been to utilize high-pressure cylinders for storage, transport and dispensing of a wide variety of gases. In these applications, gas is contained in the cylinder in a compressed state, to maximize the inventory of the gas available for dispensing and ultimate use.

Since pressure of such compressed gases typically greatly exceeds atmospheric pressure, structural integrity of the gas package is critical to safety in the use of such packages, since any leakage from a high-pressure container will quickly spread to the surrounding environment of the container. Where the gas is hazardous, e.g., toxic, pyrophoric, or otherwise detrimental to health or safety of persons exposed to same, or deleterious to the environment or operability of facilities in the vicinity of the container, structural integrity of the gas-containment package is vitally important to user acceptance and commercial success of the package.

For these reasons, it has been common practice in the gas industry to leak test gas packages, such as conventional high-pressure cylinders, e.g., by methods in which the sealed high-pressure vessel, or a portion thereof having joints or seams susceptible to leakage, is submerged in or contacted with liquid to determine the presence of leaking gas by bubble formation, or by methods using detectors that are sensitive to the gas of interest, such as leak-testing the sealed vessels with “gas sniffer” devices coupled to chemical analyzers.

In view of the safety and reliability issues involving packages of high-pressure gases in the semiconductor industry, efforts have been made in recent years to significantly increase the safety of gas packaging. This effort has produced sorbent-based fluid storage and delivery systems, such as those described in U.S. Pat. No. 5,518,528, in which gas is adsorbed and stored on a physical adsorbent in a fluid storage and dispensing vessel and is desorbed from the adsorbent and discharged from the vessel under dispensing conditions. In these systems, the gas can be stored and dispensed at sub-atmospheric pressure levels, typically below about 700 torr, Such physical adsorbent-based systems are commercially available from ATMI, Inc. (Danbury, Conn., USA) and Matheson Tri-Gas, Inc. (Parsippany, N.J., USA) under the trademarks SDS and SAGE.

More recently, an enhanced safety fluid storage and dispensing system has been developed, in which fluid is contained in a vessel having a fluid pressure regulator in the interior volume of the vessel. Such arrangement is effective to permit fluid to be stored at high pressures, with the regulator being operative to discharge fluid from the vessel only when it sees a downstream pressure that is below the set point of the regulator. Such internally disposed regulator systems are more fully described in U.S. Pat. Nos. 6,101,816 and 6,089,027, and are commercially available from ATMI, Inc. (Danbury, Conn., USA) under the trademark VAC.

Despite these developments of safer gas packaging, it remains critical for gas packages to be fabricated without the occurrence of, or potential for, gas leakage at seams, joints and fittings. Toward such objective, safe, effective and reproducible leak-testing is vital to verify that pressurized gas vessels are leak-free in character, and this is particularly true in the semiconductor manufacturing industry, where reagent gases may be extremely toxic and even lethal at low concentrations, in some instances as low as parts-per-million or even parts-per-billion.

In consequence, the art continues to seek improvements in systems and techniques for determining the presence of leaks in vessels employed for packaging of gases, and in verifying the suitability of such vessels for extended leak-free service.

### SUMMARY OF THE INVENTION

The present invention relates to apparatus and process for leak-testing of vessels employed for storage and dispensing of fluids, or of other articles required to be leak-tight in use.

In one aspect, the invention relates to a system for leak-testing an article required to be fluid leak-tight in use at a fluid-contacting region thereof, to determine fluid leakage through the article to a potential leak-expression region of the article, such system including a leak-testing fluid held in confinement by the fluid-contacting region of the article, a vacuum assembly arranged for establishing a vacuum environment at the potential leak-expression region of the article, and a leak detector arranged to detect presence or absence of the leak-testing fluid in the vacuum environment, to determine fluid leakage through the article.

In another aspect, the invention relates to an apparatus for leak-testing a vessel employed for dispensing of fluid, including an evacuatable chamber adapted to contain a vessel holding a leak-testing fluid, e.g., at superatmospheric pressure, a vacuum system arranged to pump down the evacuatable chamber to establish vacuum therein, and a leak detector joined in fluid communication with the evacuatable chamber and operative to detect leakage from the vessel holding leak-testing fluid into the chamber when pumped down by the vacuum system.

In a further aspect, the invention relates to an apparatus for leak-testing an article required to be fluid-tight in use, including an evacuatable chamber adapted to contain the article in an arrangement in which the article confines a leak-testing fluid, e.g., at superatmospheric pressure, a vacuum system arranged to pump down the evacuatable chamber to establish vacuum therein, and a leak detector joined in fluid communication with the evacuatable chamber and operative to detect leakage of leak-testing fluid from or through the article under the vacuum established in the evacuatable chamber when pumped down by the vacuum system.

A further aspect of the invention relates to a method of leak-testing an article required to be fluid leak-tight in use at a fluid-contacting region thereof, to determine fluid leakage through the article to a potential leak-expression region of the article, in which the method includes holding a leak-testing fluid in confinement by the fluid-contacting region of the article, establishing a vacuum environment at the potential leak-expression region of the article, and detecting presence or absence of the leak-testing fluid in the vacuum environment, to determine fluid leakage through the article.

A still further aspect of the invention relates to a method of leak-testing a vessel employed for dispensing of fluid, comprising introducing into the vessel a leak-testing fluid, e.g., at superatmospheric pressure, sealing the leak-testing fluid in the vessel, exposing the sealed vessel to vacuum and measuring leakage of the leak-testing fluid from the vessel.

In yet another aspect, the invention relates to an apparatus for leak-testing a vessel employed for dispensing of fluid, including a chamber adapted to (i) contain a vessel having vacuum therein, and (ii) have a leak-testing fluid introduced therein, to provide an environment of the leak-testing fluid, surrounding the vessel in the chamber; a vacuum system arranged to establish the vacuum in the vessel; and a leak detector arranged for fluid communication with the vessel having vacuum therein, and operative to detect leakage into the vessel of leak-testing fluid from the leak-testing fluid environment surrounding the vessel in the chamber.

In another aspect, the invention relates to an apparatus for leak-testing an article required to be fluid-tight in use, including: a chamber adapted to contain the article in an arrangement in which the article confines a vacuum, and the chamber has a leak-testing fluid introduced therein, so that leak-testing fluid is present in an environment surrounding the article required to be leak-tight in use; a vacuum system arranged to establish vacuum confined by the article; and a leak detector joined in fluid communication with the vacuum confined by the article and operative to detect leakage of leak-testing fluid into the vacuum confined by the article.

A still further aspect of the invention relates to a method of leak-testing a vessel employed for dispensing of fluid, comprising evacuating the vessel to establish vacuum therein, sealing the vessel, externally exposing the sealed vessel to a leak-testing fluid, and measuring leakage of the leak-testing fluid into the vessel.

Other aspects, features and embodiments of the invention will be more fully apparent from the ensuing disclosure and appended claims.

### BRIEF DESCRIPTION OF T HE DRAWINGS

FIG. 1 is a schematic view of a leak detection system according to one embodiment of the present invention.

FIG. 2 is a schematic view of a leak detection system according to another embodiment of the present invention.

FIG. 3 is a schematic representation of a leak testing system according to yet another embodiment of the invention, as adapted for automated leak-testing of multiple vessels.

FIG. 4 is a schematic view of a leak detection system according to a further embodiment of the present invention.

FIG. 5 is a schematic view of a leak testing system according to yet another embodiment of the invention, as adapted for automated leak-testing of multiple vessels.

### DETAILED DESCRIPTION OF THE INVENTION. AND PREFERRED EMBODIMENTS THEREOF

The present invention relates to apparatus and process for leak-testing of vessels employed for storage and dispensing of fluids, including vessels that are used for holding gases, as well as vessels that are used for holding pressurized liquids, and vessels that are used for holding pressurized solid source reagents that are volatilized in the vessel to yield fluid for dispensing.

The present invention is based on the discovery that the sensitivity of leak-testing of vessels containing pressurized leak-testing gas can be increased by many orders of magnitude, e.g., four or even five orders of magnitude, by subjecting the vessel being leak-tested to vacuum, and then detecting leakage from the vessel in vacuo. This increase in sensitivity of the leak-testing process was completely unexpected. Moreover the level of gas leakage that is detectable by such method and associated apparatus is reduced to such low levels that it becomes possible to qualify vessels in a highly precise manner as being free from leaks not only at the time of testing, as also as being free of the probability of later developing leaks, i.e., during the subsequent storage, transport and use of the vessel.

Although described specifically hereinafter in reference to fluid dispensing vessels of a type used in industrial applications such as semiconductor manufacturing, it will be appreciated that the apparatus and process of the invention are broadly applicable to leak testing of any vessels that are susceptible to leakage of pressurized products, as well as to leak testing of any other structural articles or elements that are required to be leak-tight in use, as containing or confining pressurized material(s).

Further, also the invention is illustratively described hereinafter as utilizing a helium detector as the leak detector for leak-testing and qualification of fluid dispensing vessels, it will be appreciated that a wide variety of other types of detectors can be employed within the broad scope of practice of the invention, such as mass spectrometer that is tuned to detect the specific leak-testing gas of interest, or a flame ionizer analyzer, a Fourier Transform-Infrared (FTIR) detector, or other suitable detector appropriate for the leak-testing gas that is involved.

Additionally, although the invention is illustratively described hereinafter as involving leak-testing of vessels with a leak-testing fluid, prior to fill of the vessels with chemical reagent product for subsequent fluid dispensing, it will be recognized that the invention may be practiced with leak-testing of the vessel after it is filled with the product of interest. For example, if the vessel is filled with arsine gas as the product to be dispensed, the post-fill leak testing can be carried out with a mass spectrometer that is tuned specifically for detection of arsine. Alternatively, both pre-fill and post-fill leak testing of the same vessel can be utilized to increase the level of assurance that the vessel will not display leaking behavior in post-fill use.

In application to a fluid storage and dispensing vessel, the present invention may be carried out for leak-testing of the vessel with imposition of vacuum either on the interior volume of the vessel, so that in-leakage into such interior volume is monitored, or alternatively, the vacuum may be imposed on the exterior of the fluid storage and dispensing vessel so that any out-leakage of gas into the vacuum environment of the vessel is detected.

The vacuum may be imposed at any suitable subatmospheric pressure level appropriate to the test and the sensitivity of the detection systems that are employed for determining the existence of leakage. Typically, it is desired to impose vacuum that is below 100 torr, more preferably below 50 torr, even more preferably below 20 torr and most preferably below 10 torr, the specific level being readily determinable within the skill of the art for a given detection system and monitored leakage component.

When helium is employed as the leak testing gas, a particularly preferred leak detector is the Alcatel AMS 142 Helium Leak Detector, commercially available from Alcatel Vacuum Technology, Paris, France. In low pressure environments, leak rates down to 10⁻¹⁰ cc helium/sec are detectable by such leak detector.

The vacuum imposed on the structure to be tested for leak-tightness may be applied by means of a suitable vacuum pump, cryopump, exposure to getters for chemisorbing gas in the environment being evacuated, etc.

The leak detector used in a given application of the invention may be calibrated using suitable calibrated sources. For example, in one embodiment of the invention, wherein helium is the leak-testing gas, calibrated sources providing leak rates of 10⁻⁷, 10⁻⁸ and 10⁻⁹ cc hydrogen/sec can be employed. The resulting calibration then is employed to ensure accuracy of the detector, which may for example being capable when properly calibrated of detecting helium leaks in the 10⁻⁷ to 10⁻⁹ cc helium/sec range.

The method of the invention may be employed to establish a pass/fail criterion for leak-tightness and acceptance or rejection of products of various types. In one embodiment of the invention, the leak-testing is conducted to determine the existence of leakage at the neck joint of a gas containment vessel, e.g., at a neck opening that is threaded to mate with a correspondingly threaded valve head assembly, e.g., including a dispensing valve and a manual actuator or automatic actuator for the valve.

In one embodiment, the present invention takes advantage of the fact that the sensitivity of leak-testing of vessel can be increased, by evacuating the vessel being leak-tested so that it contains vacuum, surrounding the vessel, or a portion thereof required to be leak-tight in use, with leak testing fluid and then detecting leakage into the evacuated vessel. Such increase in sensitivity of the leak-testing process is completely unexpected. Moreover, the level of gas leakage that is detectable by such method and associated apparatus is reduced to low levels and it becomes possible to qualify vessels, as more generally discussed hereinabove.

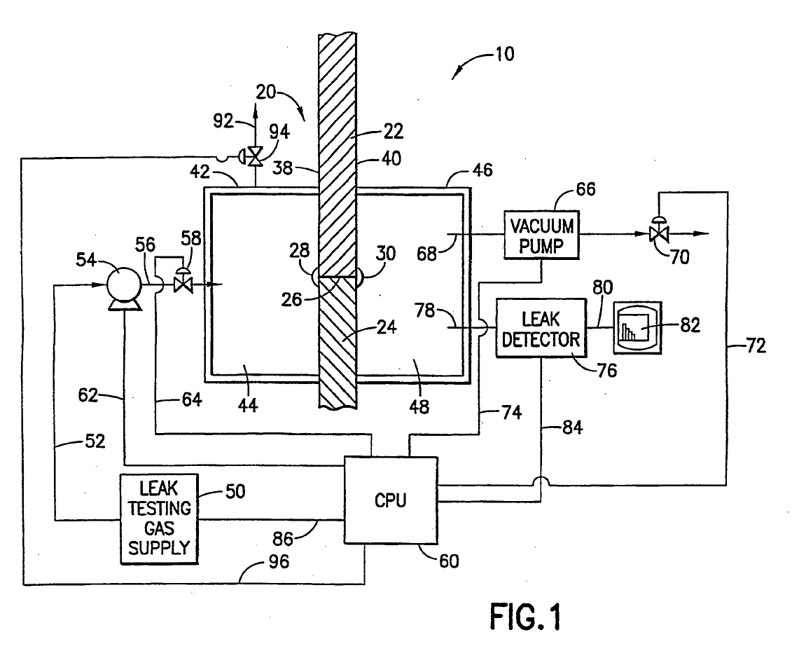

Referring now to the drawings, FIG. 1 is a schematic view of a leak detection system 10 according to one embodiment of the present invention. The system 10 as illustrated is being employed to leak test the structural article 20. Article 20 includes wall members 22 and 24 that abut one another at the bottom edge of wall member 22 and the top edge of wall member 24, thereby defining a seam 26 between the respective wall members. The wall members 22 and 24 in such manner form a wall assembly having a first surface 38 and a second surface 40. The seam 26 of the wall assembly is secured by weld 28 on the first surface 38 of the wall and by a weld 30 on the second surface 40.

In use, the wall assembly of article 20 is employed to confine a pressurized fluid and is required to be of a leak-tight character.

The leak detection system 10 used to test article 20 includes a pressurization enclosure 42 that is shown as being sealingly engaged with the first surface 38 of the article 20. By this arrangement, the enclosure 42 defines with the first surface 38 an enclosed volume 44. Joined in flow communication with the enclosed volume 44 of the enclosure 42 is a leak-testing gas supply 50, which supplies leak-testing gas to the enclosed volume 44 by means of line 52 interconnecting the leak-testing gas supply 50 with pump 54, with the pump in turn operating to deliver the leak-testing gas to the enclosed volume 44 in line 56 containing flow control valve 58 therein. The pressurization enclosure 42 is provided with a vent line 92 having flow control valve 94 therein.

The leak detection system 10 further includes a vacuum enclosure 46 that is shown as being sealingly engaged with the second surface 40 of the article 20, to form with the second surface an enclosed volume 48. Joined to the enclosed volume 48 of the vacuum enclosure 46 is a vacuum pump 66 in line 68 containing flow control valve 70 therein. Also joined to the enclosed volume 48 of the vacuum enclosure 46 by line 78 is a leak detector 76. The leak detector 76 is arranged to detect the presence or absence of the leak-testing gas in the enclosed volume 48 of the vacuum enclosure 46 and to responsively transmit an output in signal transmission line 80 to the output display monitor 82, for graphical outputting of the detection result.

The leak detection system in the FIG. 1 embodiment includes a CPU 60 that is coupled to leak-testing gas supply 50 by signal transmission line 86, to pump 54 by signal transmission line 62, to flow control valve 58 by signal transmission line 64, to flow control valve 94 by signal transmission line 96, to vacuum pump 66 by signal transmission line 74, to flow control valve 70 by signal transmission line 72, and to leak detector 76 by signal transmission line 84.

The CPU 60 in the FIG. 1 embodiment can be of any suitable type, e.g., a general purpose programmable computer, a microprocessor, a programmable logic controller, or other processor, which by means of the respective signal transmission lines 86, 62, 64, 96, 72, 74 and 84 is coupled in signal transmission relationship to pump 54, leak-testing gas supply 50, flow control valve 58, flow control valve 94, vacuum pump 66, flow control valve 70 and leak detector 76. The respective signal transmission lines enable the CPU 60 to control the operation of the components coupled thereto, in accordance with a cycle timer program or in other manner, so that the leak-testing operation is carried out in an efficient and reproducible manner.

In operation of the FIG. 1 system, the leak detector can be calibrated in any suitable manner, such as for example by connecting line 78 to a calibration standard, e.g., a source of leak detector calibration gas in a container that releases the calibration gas at a controlled accurate leak rate, so that the leak detector can be accurately calibrated by reference thereto. More than one calibration standard can be employed, to ensure that the leak detector is appropriately calibrated for subsequent leak detection operation. As another alternative, a calibration standard may be installed in the interior volume 48 of vacuum enclosure 46, and after the enclosure is pumped to establish vacuum in the enclosure, the leak detector is actuated to detect the leak rate of the calibration standard, so that the leak detector may be adjusted for accurate further operation.

Once the leak detector 76 is calibrated, the CPU by signals in lines 86, 62, 64 and 96 causes leak testing gas supply 50 to open for dispensing, flow control valves 58 and 94 to open, and pump 54 to pump leak testing gas from the supply 50 through line 52 into pressurization chamber 42 and into vent line 92 for purging of the pressurization chamber. After the pressurization chamber 42 has been purged of gas other than the leak testing gas, the CPU transmits a signal in line 96 to close the flow control valve 94. The flow of leak testing gas into chamber 42 continues until the chamber is at a predetermined pressure of leak testing gas, whereupon the CPU 60 transmits a signal in line 64 to shut the flow control valve 58.

Contemporaneously (before, during and/or after the pressurization of the chamber 42 with leak testing gas), the vacuum pump 66 is actuated by a control signal from CPU 60 in line 74 and flow control valve 70 is opened by control signal from CPU 60 in line 72, so that the gas resident in the vacuum chamber 46 is exhausted from the chamber in line 68 by the action of the vacuum pump, so that a vacuum condition is established in the vacuum chamber 46. The vacuum pump upon reaching of the desired vacuum condition may be shut off by the CPU and the valve 70 closed to maintain the vacuum condition in the vacuum chamber, or alternatively the pump 66 may be operated in a back-up mode, to maintain the vacuum pressure in the chamber 46 at a desired level.

With the vacuum condition established in the vacuum chamber 46, the leak detector is actuated by a signal from CPU 60 in line 84, whereby sampling of the vacuum chamber environment is carried out by flow (diffusion) of gas from the interior volume 48 of the vacuum chamber 46 to the leak detector 76. The leak detector 76 responsively transmits an output signal in line 80 to the monitor 82 for graphical outputting of the leak testing operation results. The leak detector can also contain or be associated with alarm or recorder devices indicating when there is a leakage above the predetermined threshold for acceptance or rejection of the article 20 as being suitably leak-tight in character, or alternatively as lacking such leak-tightness. For this purpose, the leak detector can output a signal to the CPU 60 in line 84 to terminate the leak-testing, when a defective article 20 is determined to be unsuitable for its intended fluid containment or fluid confinement application.

When the leak testing determination has been made, the CPU functions to deactuate the leak testing system so that the article 20 can be disengaged from the respective pressurization and vacuum chambers, e.g., to prepare the system for leak testing of the next succeeding article to be assessed for leak-tightness.

It will be appreciated that in lieu of separate leak detector and vacuum pump components in the system as shown in FIG. 1, the system alternatively can be configured so that the vacuum pump and leak detector are consolidated in an integrated, unitary leak detector and vacuum pump assembly. Further, although it is preferred to introduce the leak-testing fluid into the vessel at superatmospheric pressure, it will be appreciated that the leak-testing fluid may alternatively in some applications be introduced at atmospheric, or even subatmospheric pressure (although any subatmospheric pressure should be sufficiently above the vacuum pressure level to increase efficient leak-testing).

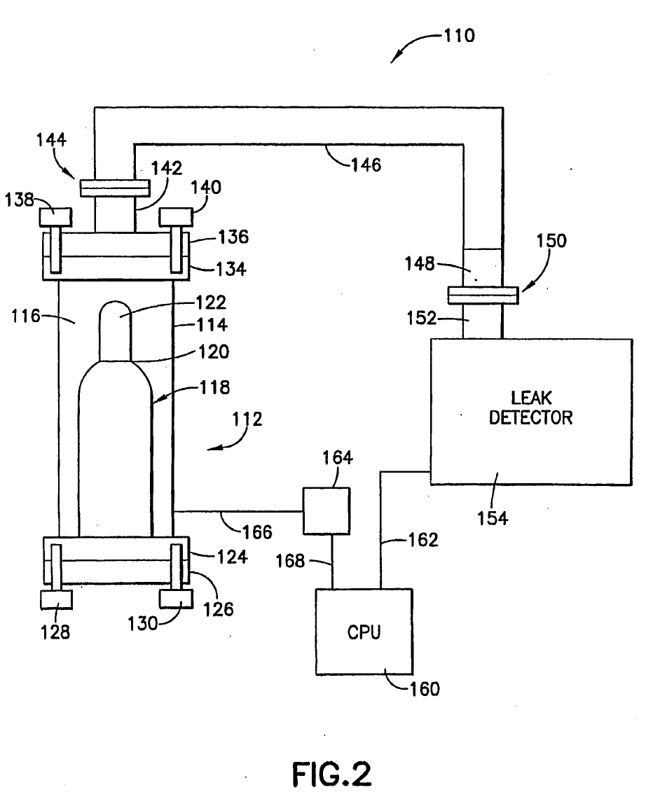

FIG. 2 is a schematic view of a leak detection system according to another embodiment of the present invention. The illustrated leak-testing system 110 includes evacuatable chamber 112 including chamber housing 114 circumscribing an enclosed interior volume 116 between flange elements at lower and upper ends of the housing. The lower end of the housing is bounded by a flange assembly including upper flange 124, lower flange 126 and screw-type mechanical fasteners 128 and 130 interconnecting such flanges. The upper flange 124 of such assembly may be brazed, welded, soldered or otherwise secured to the chamber housing 114, and advantageously is of a same size as the lower flange 126, so as to facilitate mating and engagement of such flanges to form the flange assembly.

In like manner, the chamber housing 114 at its upper end has a flange 134 secured thereto, and matably engagable with flange 136, so that the respective flanges can be secured in position by screw-type mechanical fasteners 138 and 140, as shown.

In the flange assembly including upper flange 134 and lower flange 136, the upper flange has a port extension 142 secured thereto. The port extension 142 terminates in a flange that is matably engaged with a complimentary flange of the conduit 146. By this arrangement, the respective flanges of the port extension and conduit form a flange assembly 144. This flange assembly may be mechanically interlocked in a conventional or otherwise known manner, e.g., by a collar clamp, or by interconnecting bolt and nut assemblies, or in other appropriate manner.

The conduit 146 at its opposite end from the flange assembly 144 is secured to a terminal section 148, such as by welding, brazing, soldering, bonding, or use of mechanical fasteners. The terminal section 148 of conduit 146 terminates in a flange that is matably engageable with a complimentary flange of the port extension 152, thereby forming a flange assembly 150. Such flange assembly also can be mechanically interlocked in a conventional or otherwise known manner, e.g., by a collar clamp, or by interconnecting bolt and nut assemblies, or in other appropriate manner.

The port extension 152 is coupled with leak detector 154. The leak detector 154 may be of any suitable type, having leak detection capability for the leak-testing gas that is present in the vessels being leak-tested.

The leak detector 154 can be constructed and arranged so that it has the capability for (i) pumping down to vacuum pressure levels and (ii) upon achieving a predetermined vacuum pressure, actuating the leak detection capability of the device. In this mode, the leak detector may be actuated to pump down the chamber housing 114 by evacuating gas from the interior volume 116 of the housing and flowing it through the conduit 146 for discharge to the ambient environment of the system. After the chamber housing and conduit 146 have been evacuated to a predetermined pressure, the detection capability of the leak detector is activated, to sense and responsively produce an output correlative of the presence or absence of the leak-testing gas in the vacuum environment of the vessel being tested.

Alternatively, the chamber housing may be evacuated for leak testing by a separate, dedicated vacuum pump, and after the suitable vacuum level has been established in the environment of the vessel, communication of the leak detector to the vacuum environment is effected, so that the detector thereafter can sense and provide a corresponding output of presence or absence of the leak-testing gas in the vacuum environment.

To carry out the leak-testing method in the system of FIG. 1 using the dedicated vacuum pump 164, the system is arranged so that the chamber housing 114 is coupled in flow relationship by vacuum line 166 to vacuum pump 164. When the vacuum pump is actuated, the gas contents of the interior volume 116 of the chamber housing 114 are withdrawn to establish a vacuum condition in such interior volume, as well as the conduit 146 coupled therewith.

The leak detector 154 in such arrangement can be arranged to automatically turn on at the point at which the pump-down of the chamber housing 114 yields a selected pressure level, e.g., 10 torr, in the housing 114 and conduit 146. Alternatively, the leak detector can be turned on in accordance with a cycle time program, so that after a predetermined period of pumping to vacuum level, the leak detector is actuated to provide an output correlative of the presence or absence of the leak-testing gas.

In the arrangement shown in FIG. 2, the vacuum pump 164 is joined, via signal transmission line 168, to central processing unit (CPU) 160. The CPU 160 additionally is coupled to leak detector 154 by signal transmission line 162. The CPU can be of any suitable type, as for example a general purpose programmable computer, microprocessor, programmable logic controller, etc.

A gas package 118 is shown as disposed in the interior volume 116 of chamber housing 114. Such gas package comprises a cylindrically-shaped tank having a neck region 120 to which is joined a valve head assembly 122. The valve head assembly may include a flow control valve that is manually actuated by a user of the vessel, or alternatively, the valve head assembly can include a valve actuator that is automatically acuatable by the CPU or other control device to effect opening or closing of the valve therein.

The vessel for purposes of the leak testing may contain any suitable type of leak detector gas for which the system is effective to sense presence or absence of a leak from the vessel. Examples include, without limitation, hydrogen, oxygen, helium, nitrogen, ammonia, arsine, phosphine, silane, boron trifluoride, boron trichloride, acetylene, and chlorine. The leak detector gas used for testing the leak-tightness of the vessel thus may be of any appropriate type, and may be the same as, or alternatively different from, the gas or other material that is contained in the vessel in its normal intended use.

In one embodiment of the operation of the system illustratively shown and described with reference to FIG. 2, the vessel 118 is filled with a leak detection gas, e.g., helium, at suitable superatmospheric pressure, as for example pressure in a range of from about 300 to about 2000 pounds per square inch gauge (psig).

The vessel 118 after filling with the leak testing gas is placed in the housing chamber 114. The vacuum pump 164 then is actuated to withdraw the gas from interior volume 16 of the chamber housing 114 and conduit 146, until a predetermined pressure is reached. The leak detector 154 thereupon is actuated to sense gas leakage from the vessel, as flowing and/or diffusing through conduit 146 to the leak detector 154.

Since the housing chamber 114 in the practice of the invention as illustrated in FIG. 2 is evacuated to remove atmospheric gases therefrom prior to leak testing, the loss of sensitivity that has plagued prior art leak detection systems is eliminated. As a result, the detection limit of the leak testing operation has been found to be unexpectedly increased in magnitude, e.g., by a magnitude of 5 times higher than the detection limit that is achievable when leak testing is conducted in an ambient environment at atmospheric pressure.

As a specific example, in an ambient environment at atmospheric pressure, where helium is being used as the pressurizing gas for a vessel of the type described in U.S. Pat. No. 5,518,528, a leak detector can detect leakage only to levels on the order of about 1×10⁻⁶ standard atmospheric-cc/sec (standard atmospheric-cc/sec being volumetric flow rate of gas at standard pressure and temperature (1 atmosphere, 25° C.) conditions; 1 atmospheric cc/sec=1.013 mBar-liter/sec). By contrast, the system and method of the present invention, utilizing a vacuum arrangement and leak detector with helium as the leak-detection gas, can readily achieve leak detection levels as low as 1×10⁻¹¹ standard atmospheric-cc/sec. This represents a five orders of magnitude improvement in the sensitivity of the leak detection system by the apparatus and method of the present invention. In addition, the apparatus and method of the invention as a result of such high sensitivity enable vessels to be identified that will be susceptible to problematic leakage in subsequent use.

The apparatus and method of the present invention thereby unexpectedly achieve a predictive utility, in the ability to identify vessels that are likely to develop problematic leakage in later use. Vessels that have been leak tested by currently conventional leak test methods and found to be leak-free nonetheless often develop leaks in the field, a fact that has frustrated quality assurance efforts to identify and reject such vessels at the manufacturing facility and/or gas fill site. This circumstance is due to the fact that many leaks are not detected by the conventional leak-testing, because they are below the detection limit of the conventional technique, but such extremely small leakages nonetheless often increase in magnitude after the shipment from the factory of the pressurized vessel containing material for subsequent dispensing, due to subsequent transportation, storage and installation effects such as vibration, thermal cycling, etc.

Generally, it has been determined that compressed gas cylinders that manifest leakage in the factory or fill site, which is less than 1×10⁻⁸ standard atmospheric-cc/sec., do not normally manifest detectable leaks in the field. Accordingly, since the detection limits of the apparatus and method of the invention are substantially increased in relation to those of the prior art, to below such leakage level of 1×10⁻⁸ standard atmospheric-cc/sec, the apparatus and method of the invention can easily detect such “future leakers,” thereby dramatically decreasing the incidence of field leaks in vessels that have previously been qualified as suitable for pressurized gas service.

In general, the method and apparatus of the present invention are usefully employed to determine leakage levels that are significantly below those of conventional leak detection approaches. Current leak detection techniques in the art are able to detect leakages only down to the level of 1×10⁻⁶ standard atmospheric-cc/sec. The present invention thus achieves a significant advance in the art by its leak detection capability below the conventional detection limit of 1×10⁻⁶ standard atmospheric-cc/sec. The present invention permits the pass/fail leak rate criterion for acceptance or rejection of fluid containment products to be at a value in a suitable range appropriate to the specific products being qualified, e.g., a value in a range of from 1×10⁻⁷ standard atmospheric-cc/sec to 1×10⁻¹¹ standard atmospheric-cc/sec. In a specific embodiment, the pass/fail value may be a value in a range of from 1×10⁻⁷ standard atmospheric-cc/sec to 1×10⁻⁹ standard atmospheric-cc/sec. For fluid dispensing vessels of the types described in aforementioned U.S. Pat. Nos. 5,518,528, 6,101,816 and 6,089,027, the disclosures of which hereby are incorporated herein by reference in their entireties, an appropriate pass/fail value in one embodiment of the invention is 1×10⁻⁸ standard atmospheric-cc/sec, which is a detection value that provides good assurance that leaks will not develop in subsequent transport, storage and/or use, and at the same time is not so restrictive that it results in rejection of vessels that will be appropriately leak-free in such subsequent transport, storage and/or use.

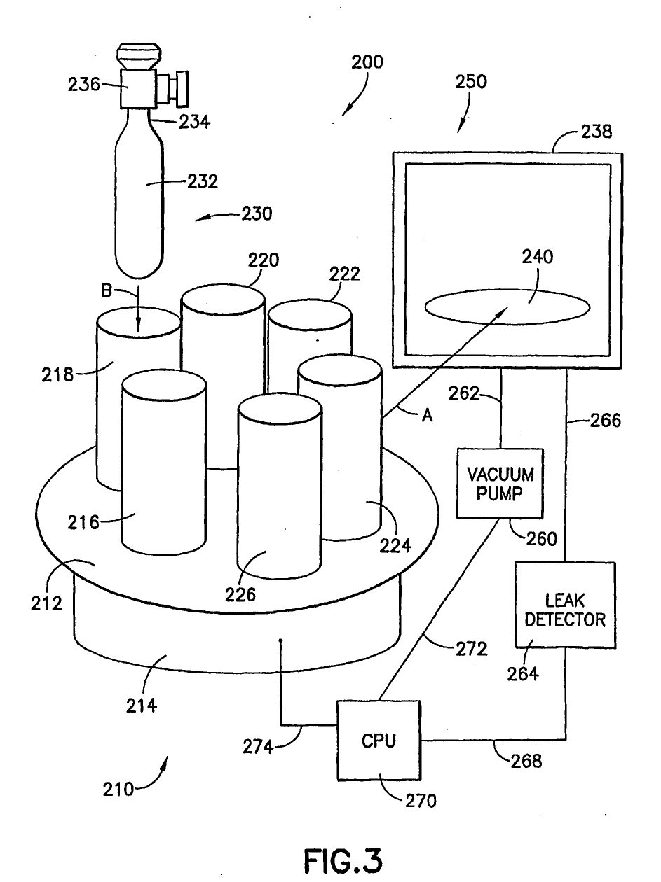

FIG. 3 is a schematic representation of a leak testing system according to another embodiment of the invention, as adapted for automated leak-testing of multiple vessels.

The leak detection system 200 shown in FIG. 3 provides the capability to automatically leak test multiple vessels, and includes a multi-vessel test assembly 210, including a support 212 of disk-like form, on which is mounted a series of cylindrical vacuum chambers 216, 218, 220, 222, 224 and 226. The support 212 is mounted on a motive structure 214, which may for example further include tracks, an extendible mechanical arm or other associated motive structure (not shown in FIG. 3), by which the multi-vessel test assembly 210 can be translated in the direction indicated by arrow A, into the vacuum housing 250.

The vacuum housing 250 includes an enclosure 238 having a support 240 therein, on which the multi-vessel test assembly 210 reposes, subsequent to its translation into the vacuum housing 250.

Prior to being translated into the vacuum housing 250, the multi-vessel test assembly 210 is loaded with the vessels to be leak-tested. Such loading may be carried out in a manual, automated, or semi-automated manner.

FIG. 3 illustratively shows a vessel 232 having a valve head assembly 236 attached to the neck 234 of the vessel, as it is inserted into cylindrical vacuum chamber 218 (in the direction indicated by arrow B).

The multi-vessel test assembly 210 in one embodiment is configured with a rotatable carousel that is rotated to permit an operator or loading machine (not shown) to insert a vessel pressurized with leak-testing fluid into each of the respective cylindrical vacuum chambers. After such filling, the multi-vessel test assembly 210 is translated into the enclosure 250 by the motive structure 214, and the enclosure is sealed, as for example by closure of a door, cover or other member of the enclosure. The enclosure then is pumped down to vacuum level, by means of a vacuum pumping capability of the leak detector 264 if such leak detector has integral pumping capability, or alternatively (or additionally) by means of the vacuum pump 260 joined to housing 250 by evacuation line 262. In this embodiment, the vacuum pump 260 is controlled by a central processor unit (CPU) 170 that transmits control signals to vacuum pump 260 by means of signal transmission line 172.

When the vacuum pump 260 has operated to effect the appropriate vacuum condition in the housing 250, each of the vessels in turn is tested. For this purpose, each of the cylindrical vacuum chambers 216, 218, 220, 222, 224 and 226 may have detachable covers that are maintained in a sealed state in all but one cylindrical chamber, which is opened for the leak-test of the associated vessel in such vacuum chamber while all other vacuum chambers are maintained in sealed condition, and with each of the respective vessels in turn being exposed to vacuum within the housing 250 and subjected to leak testing.

For this purpose, the housing 250 may contain a suction head (not shown) or other structure that selectively engages each of the vacuum chambers in turn and exposes the vessels therein sequentially to the vacuum test condition.

During the exposure to vacuum of a given single vessel, the leak detector 264 is actuated by the CPU 270, by a control signal transmitted to the leak detector 264 in transmission line 168, to actuate the leak detection process.

As shown in FIG. 2, the CPU may also be coupled in controlling relationship to motive structure 214 by signal transmission line 274.

By this integrated control arrangement the CPU can be actuated to translate the assembly 210 into the evacuation enclosure 250 after each of the vacuum chambers 216, 218, 220, 222, 224 and 226 is filled with a pressurized vessel. Once the assembly of vessels to be leak tested is reposed in the enclosure 250, the CPU actuates the closure and sealing of the housing 250, and then actuates the vacuum pump 260 to pump down the enclosure 250 or a sampling region therein coupled with a given cylindrical vacuum chamber, to create vacuum conditions suitable for leak testing, with the CPU concurrently actuating the leak detector 264 so that the leak detector senses any gas leakage from the vessel being tested.

In this manner, the system shown in FIG. 3 is automated to impose vacuum conditions on the vessel being leak tested and to detect any leakage event, in a highly efficient and reproducible manner.

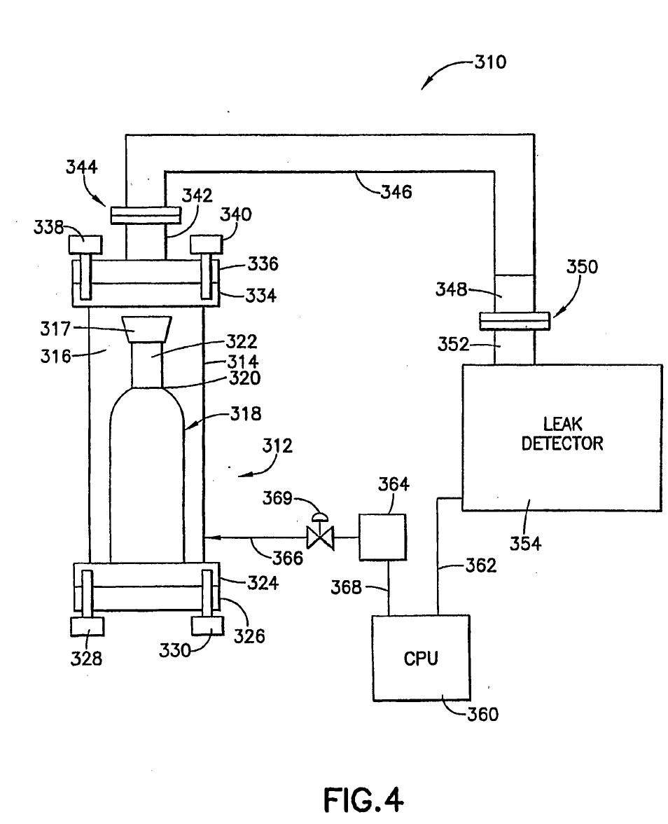

FIG. 4 is a schematic view of a leak detection system according to one embodiment of the present invention. The illustrated leak-testing system 310 includes chamber 312 including chamber housing 314 circumscribing an enclosed interior volume 316 between flange elements at lower and upper ends of the housing. The lower end of the housing is bounded by a flange assembly including upper flange 324, lower flange 326 and screw-type mechanical fasteners 328 and 330 interconnecting such flanges. The upper flange 324 of such assembly may be brazed, welded, soldered or otherwise secured to the chamber housing 314, and advantageously is of a same size as the lower flange 326, so as to facilitate mating and engagement of such flanges to form the flange assembly. A fluid dispensing vessel 318 is contained in the interior volume 316 of the chamber housing 314, having a neck 320 to which is joined a valve head 322, joined in turn to the vacuum head 317 to form a leak-tight fitting through which the interior volume of the vessel 318 can be evacuated by vacuum pumping.

Joined in flow communication to the chamber housing 314, by flow line 366 containing flow control valve 369 therein, is a source 364 of leak-testing fluid. The leak-testing fluid source 364 may be a vessel or container holding the leak-testing fluid at appropriate pressure, so that it is flowable to the interior volume 316 of the chamber housing 314 to fill the interior volume with an environment of leak-testing fluid surrounding the vessel to be tested for leak-tightness.

The chamber housing 314 at its upper end has a flange 334 secured thereto, and matably engagable with flange 336, so that the respective flanges can be secured in position by screw-type mechanical fasteners 338 and 340, as shown.

In the flange assembly including upper flange 334 and lower flange 336, the upper flange has a port extension 342 secured thereto. The port extension 342 terminates in a flange that is matably engaged with a complimentary flange of the conduit 346. By this arrangement, the respective flanges of the port extension and conduit form a flange assembly 344. This flange assembly may be mechanically interlocked in a conventional or otherwise known manner, e.g., by a collar clamp, or by interconnecting bolt and nut assemblies, or in other appropriate manner.

The port extension 342 is coupled through flanges 334 and 336 with a vacuum head 317, by which the vessel 318 in chamber 312 can be evacuated, as hereinafter more fully described.

The conduit 346 at its opposite end from the flange assembly 344 is secured to a terminal section 348, such as by welding, brazing, soldering, bonding, or use of mechanical fasteners. The terminal section 348 of conduit 346 terminates in a flange that is matably engageable with a complimentary flange of the port extension 352, thereby forming a flange assembly 350. Such flange assembly also can be mechanically interlocked in a conventional or otherwise known manner, e.g., by a collar clamp, or by interconnecting bolt and nut assemblies, or in other appropriate manner.

The port extension 352 is coupled with leak detector 354. The leak detector 354 may be of any suitable type, having leak detection capability for the leak-testing gas that is present in the vessels being leak-tested.

The leak detector 354 can be constructed and arranged so that it has the capability for (i) pumping down to vacuum pressure levels and (ii) upon achieving a predetermined vacuum pressure, actuating the leak detection capability of the device. In this mode, the leak detector may be actuated to pump down the vessel 318 by evacuating gas from the interior volume of the vessel and flowing it through the vessel valve head 322, vacuum head 317 joined leak-tightly to the vacuum head, and conduit 346, for discharge to the ambient environment of the system. After the vessel and conduit 346 have been evacuated to a predetermined pressure, and sufficient volume of leak-testing fluid has been flowed into the chamber housing 314 from the source 364 in line 366 (with valve 369 being open), the detection capability of the leak detector is activated, to sense and responsively produce an output correlative of the presence or absence of the leak-testing gas in the vacuum environment in the vessel being tested.

Alternatively, the vessel may be evacuated for leak testing by a separate, dedicated vacuum pump, and after the suitable vacuum level has been established in the interior of the vessel, communication of the leak detector to the vacuum in the vessel interior is effected, so that the detector thereafter can sense and provide a corresponding output of presence or absence of the leak-testing gas in the interior vacuum environment of the vessel.

To carry out the leak-testing method in the system of FIG. 4, leak-testing fluid is flowed into the housing 314 from source 364 in line 366, as described above. When the vacuum pump is actuated, the gas contents of the interior volume of the vessel 318 are withdrawn to establish a vacuum condition in such interior volume, as well as the conduit 346 coupled therewith.

The leak detector 354 in such arrangement can be arranged to automatically turn on at the point at which the pump-down of the vessel interior volume yields a selected pressure level, e.g., 10 torr, within the vessel 318 and conduit 346. Alternatively, the leak detector can be turned on in accordance with a cycle time program, so that after a predetermined period of pumping to vacuum level, the leak detector is actuated to provide an output correlative of the presence or absence of the leak-testing gas leakage into the vessel.

In the arrangement shown in FIG. 4, the leak-testing fluid source 364 is joined, via signal transmission line 368, to central processing unit (CPU) 360. The CPU 360 additionally is coupled to leak detector 354 by signal transmission line 362. The CPU can be of any suitable type, as for example a general purpose programmable computer, microprocessor, programmable logic controller, etc. for carrying out the leak-testing operation in accordance with a cycle time program, or in other automated manner. For example, the flow control valve 169 may be responsive to the control signal sent to source 364, so that the fluid is dispensed to the chamber housing interior volume 316 in a controlled or sequential manner, with respect to other steps of the leak-testing procedure.

The vessel for purposes of the leak testing may be exteriorly exposed to any suitable type of leak detector gas for which the system is effective to sense presence or absence of a leak into the vessel. Examples include, without limitation, hydrogen, oxygen, helium, nitrogen, ammonia, arsine, phosphine, silane, boron trifluoride, boron trichloride, acetylene, and chlorine. The leak detector gas used for testing the leak-tightness of the vessel thus may be of any appropriate type, and may be the same as, or alternatively different from, the gas or other material that is contained in the vessel in its normal intended use.

In one embodiment of the operation of the system illustratively shown and described with reference to FIG. 4, the vessel 318 is exposed to a leak detection gas, e.g., helium, at suitable superatmospheric pressure, as for example pressure in a range of from about 300 to about 2000 pounds per square inch gauge (psig).

The vessel 318 initially is placed in the housing chamber 314 and coupled to the vacuum head 317 at the valve head 322 of the vessel. The chamber housing then is filled to a desired extent with the leak-testing fluid from source 364, and valve 366 then is closed. The vacuum pump in the leak detector 354 then is actuated to withdraw the gas from the interior volume of the vessel, until a predetermined vacuum level is reached. The leak detector 354 thereupon is actuated to sense gas leakage into the vessel, as flowing and/or diffusing through conduit 346 to the leak detector 354.

Since the vessel is evacuated to remove atmospheric gases therefrom prior to leak testing, the loss of sensitivity that has plagued prior art leak detection systems is eliminated. As a result, the detection limit of the leak testing operation is increased in magnitude, relative to the detection limit that is achievable when leak testing is conducted in an ambient environment at atmospheric pressure.

The apparatus and method of the invention as a result of such high sensitivity enable vessels to be identified that will be susceptible to problematic leakage in subsequent use.

The apparatus and method of the present invention thereby unexpectedly achieve a predictive utility, in the ability to identify vessels that are likely to develop problematic leakage in later use. Vessels that have been leak tested by currently conventional leak test methods and found to be leak-free nonetheless often develop leaks in the field, a fact that has frustrated quality assurance efforts to identify and reject such vessels at the manufacturing facility and/or gas fill site. This circumstance is due to the fact that many leaks are not detected by the conventional leak-testing, because they are below the detection limit of the conventional technique, but such extremely small leakages nonetheless often increase in magnitude after the shipment from the factory of the pressurized vessel containing material for subsequent dispensing, due to subsequent transportation, storage and installation effects such as vibration, thermal cycling, etc.

Generally, it has been determined that compressed gas cylinders that manifest leakage in the factory or fill site, which is less than 1×10⁻⁸ standard atmospheric-cc/sec., do not normally manifest detectable leaks in the field. Accordingly, since the detection limits of the apparatus and method of the invention are substantially increased in relation to those of the prior art, to below such leakage level of 1×10⁻⁸ standard atmospheric-cc/sec, the apparatus and method of the invention can easily detect such “future leakers,” thereby dramatically decreasing the incidence of field leaks in vessels that have previously been qualified as suitable for pressurized gas service.

In general, the method and apparatus of the present invention are usefully employed to determine leakage levels that are significantly below those of conventional leak detection approaches. Current leak detection techniques in the art are able to detect leakages only down to the level of 1×10⁻⁶ standard atmospheric-cc/sec. The present invention thus achieves a significant advance in the art by its leak detection capability below the conventional detection limit of 1×10⁻⁶ standard atmospheric-cc/sec. The present invention permits the pass/fail leak rate criterion for acceptance or rejection of fluid containment products to be at a value in a suitable range appropriate to the specific products being qualified, e.g., a value in a range of from 1×10⁻⁷ standard atmospheric-cc/sec to 1×10⁻¹¹ standard atmospheric-cc/sec. In a specific embodiment, the pass/fail value may be a value in a range of from 1×10⁻⁷ standard atmospheric-cc/sec to 1×10⁻⁹ standard atmospheric-cc/sec. For fluid dispensing vessels of the types described in aforementioned U.S. Pat. Nos. 5,518,528, 6,101,816 and 6,089,027, the disclosures of which hereby are incorporated herein by reference in their entireties, an appropriate pass/fail value in one embodiment of the invention is 1×10⁻⁸ standard atmospheric-cc/sec, which is a detection value that provides good assurance that leaks will not develop in subsequent transport, storage and/or use, and at the same time is not so restrictive that it results in rejection of vessels that will be appropriately leak-free in such subsequent transport, storage and/or use.

In operation of the FIG. 4 system, the leak detector can be calibrated in any suitable manner, such as for example by a calibration standard, e.g., a source of leak detector calibration gas in a container that releases the calibration gas at a controlled accurate leak rate, so that the leak detector can be accurately calibrated by reference thereto. More than one calibration standard can be employed, to ensure that the leak detector is appropriately calibrated for subsequent leak detection operation.

It will be appreciated that in lieu of an arrangement in which the vacuum pump and leak detector are consolidated in an integrated, unitary leak detector and vacuum pump assembly as shown in FIG. 4, separate leak detector and vacuum pump components can alternatively be employed in the system.

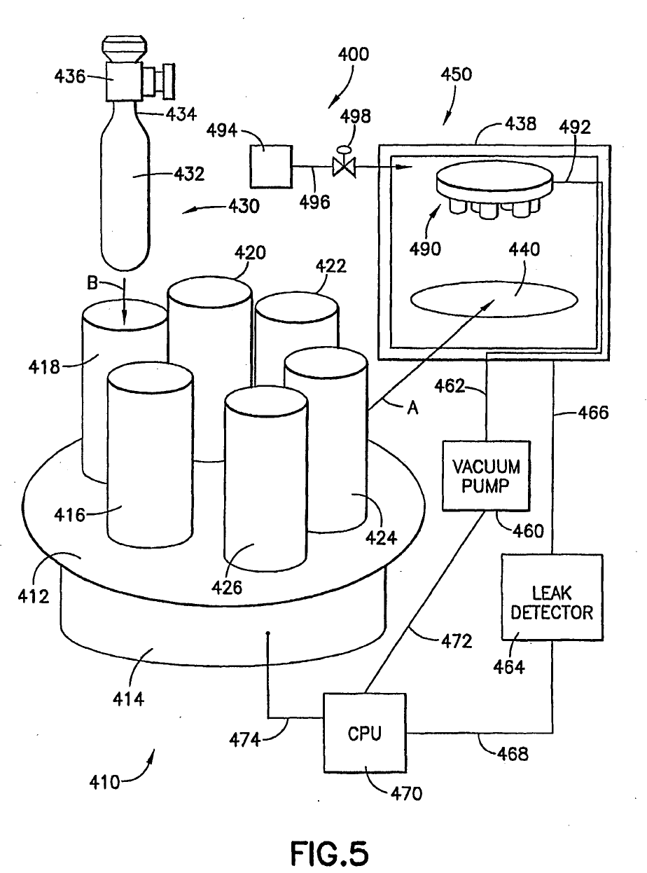

FIG. 5 is a schematic representation of a leak testing system according to another embodiment of the invention, as adapted for automated leak-testing of multiple vessels.

The leak detection system 400 shown in FIG. 5 provides the capability to automatically leak test multiple vessels, and includes a multi-vessel test assembly 410, including a support 412 of disk-like form, on which is mounted a series of cylindrical chambers 416, 418, 420, 422, 424 and 426. The support 412 is mounted on a motive structure 414, which may for example further include tracks, an extendible mechanical arm or other associated motive structure (not shown in FIG. 5), by which the multi-vessel test assembly 410 can be translated in the direction indicated by arrow A, into the housing 450.

The housing 450 includes an enclosure 438 having a support 440 therein, on which the multi-vessel test assembly 410 reposes, subsequent to its translation into the housing 450. The housing also includes a vacuum head 490, which is joined to vacuum and leak detection line 492, whereby the multiple vessels can be evacuated to suitable vacuum levels by action of the pump 460, joined by pump line 462 to the vacuum and leak detection line 492. The vacuum and leak detection line 492 is also joined to the leak detection line 466 associated with leak detector 464.

Prior to being translated into the vacuum housing 450, the multi-vessel test assembly 410 is loaded with the vessels to be leak-tested. Such loading may be carried out in a manual, automated, or semi-automated manner.

FIG. 5 illustratively shows a vessel 432 having a valve head assembly 436 attached to the neck 434 of the vessel, as it is inserted into cylindrical chamber 418 (in the direction indicated by arrow B).

The multi-vessel test assembly 410 in one embodiment is configured with a rotatable carousel that is rotated to permit an operator or loading machine (not shown) to insert a vessel into each of the respective cylindrical chambers. After such filling, the multi-vessel test assembly 410 is translated into the enclosure 450 by the motive structure 414, and the enclosure is sealed, as for example by closure of a door, cover or other member of the enclosure. The enclosure then is filled with leak-testing gas from source 494 thereof, as joined to the enclosure 450 by feed line 496 containing flow control valve 498 therein, and the vessels are connected to the vacuum head 490 and the vacuum pump is actuated to pump the vessels down to vacuum level, by means of the vacuum pump 460 joined to vacuum and leak detection line 492 in housing 450 via the evacuation line 462. In this embodiment, the vacuum pump 460 is controlled by a central processor unit (CPU) 470 that transmits control signals to vacuum pump 460 by means of signal transmission line 472.

When the vacuum pump 460 has operated to effect the appropriate vacuum condition in the vessels in housing 450, each of the vessels in turn is tested in the respective cylindrical chamber 416, 418, 420, 422, 424 and 426.

During the exposure to vacuum of a given single vessel, the leak detector 464 is actuated by the CPU 470, by a control signal transmitted to the leak detector 464 in transmission line 468, to actuate the leak detection process.

As shown in FIG. 5, the CPU may also be coupled in controlling relationship to motive structure 414 by signal transmission line 474.

By this integrated control arrangement the CPU can be actuated to translate the assembly 410 into the evacuation enclosure 450 after each of the chambers 416, 418, 420, 422, 424 and 426 is filled with a pressurized vessel. Once the assembly of vessels to be leak tested is reposed in the enclosure 450, the CPU actuates the closure and sealing of the housing 450, and the enclosure is filled with leak-testing fluid from source 494, and then the CPU 470 actuates the vacuum pump 460 to pump down the vessels in the enclosure 450, to create vacuum conditions suitable for leak testing, following which the CPU actuates the leak detector 464 so that the leak detector senses any gas leakage into the vessel being tested.

In this manner, the system shown in FIG. 5 is automated to impose vacuum conditions on the vessel being leak tested and to detect any leakage event, in a highly efficient and reproducible manner.

It will be appreciated that the apparatus and method of the invention may be utilized in respect of any structures, structural members, packaging, vessels, fluid containment devices, etc. that must maintain leak-tightness in use.

The advantages and features of the invention are further illustrated with reference to the following example, which is not to be construed as in any way limiting the scope of the invention but rather as illustrative of one embodiment of the invention in a specific application thereof.

### EXAMPLE 1

Inboard helium leak checking of SDS3 or 2.2L VAC cylinders (ATMI, Inc., Danbury, Conn., USA) is carried out by the following procedure.

A system of the type shown schematically in FIG. 2 is employed. The leak detector is an Alcatel ASM 142 helium leak detector which displays leak rate and system vacuum. The leak detector is actuated by switching the main power toggle switch to the “ON” position. The leak detector will then automatically begin start-up checks and then perform a self-calibration.

When the leak detector successfully completes start-up and calibration procedures, an audible message will announce the system is ready for testing and the leak detector display will indicate, “Ready for Testing”. At this point the cycle button is depressed to initiate a test.

The inboard test port of the helium leak detector is connected by a stainless steel bellows line to the inlet of the leak test chamber. The leak detector is calibrated with a certified helium leak rate using a calibrated leak standard that is sealed in the test chamber after the leak test valve is opened.

After sealing the test chamber with the test chamber flange, the “cycle” button on the Alcatel ASM 142 is depressed to initiate the chamber calibration test. After successful pump down of the system, the helium reading is observed on the leak detector display. After a stable reading is achieved, the chamber calibration leak test reading is determined to be within 5% of the stated certified calibration. After calibration of the chamber, the cycle button on the leak detector is pressed to vent the leak chamber to atmospheric pressure. The flange bolts on the chamber then are loosened and the chamber flange is removed. Next, the helium certified leak standard is removed from the chamber, and the leak valve is closed.

The cylinder leak testing then is conducted according to the following test procedure:

Step 1: Pressurize the cylinder to be tested with 300 PSIG of 100% ultra-high purity helium. Place the helium filled cylinder to be tested into the leak test chamber and seal the inlet opening flange.

Step 2: Initiate the leak test cycle by depressing the “cycle” button on the leak detector. The leak detector will proceed to pump down the leak test chamber until a sufficient vacuum is reached for leak testing.

Step 3: After the leak detector commences helium leak detection, wait five minutes for the helium signal to stabilize.

Step 4: Observe the magnitude of the leak by viewing leak detector display. A helium signal greater than 1.013×10⁻⁸ mbar-l/sec is considered a leak. Record the leak test result next to the serial number tested on the cylinder lot traveler. If the cylinder fails the leak test it may be retested. In the case of a retest, the chamber is vented by pressing the cycle button on the leak detector and then a second test is performed as before. If the cylinder fails to meet the leak test requirements on the second test, the cylinder is rejected and is removed from the lot of acceptable cylinders.

Step 5: Upon completion of the leak check the leak test chamber is vented by depressing the “cycle” button on the leak detector. The cylinder may be safely removed and another cylinder tested.

### EXAMPLE 2

A valved empty cylinder is connected to an Alcatel ASM-142 helium leak detector. The unit has a helium sensitivity that can be related to a minimum leak rate detection limit of 1×10⁻⁹ cc He/sec when gas is introduced into the unit. The unit obtains the sample by subjecting the feed line to a vacuum and drawing in the sample. The feed line is connected to the cylinder, so that the entire cylinder is subjected to the vacuum capability of 1×10⁻⁶ torr. While subject to a vacuum, helium gas is introduced in a controlled manner to various potential leak points or threaded connections on the external valve (helium gas is free-flowed over the test area). The vacuum in the cylinder draws in the helium through any leak sites, and the unit detects and measures the helium strength of entry. The strength of entry can be equated to a leak rate. By controlling the helium gas exposure to the valve, a specific leak rate can be assigned to each valve component area measured.

### INDUSTRIAL APPLICABILITY

While the invention has been has been described herein in reference to specific aspects, features and illustrative embodiments of the invention, it will be appreciated that the utility of the invention is not thus limited, but rather extends to and encompasses numerous other variations, modifications and alternative embodiments, as will suggest themselves to those of ordinary skill in the field of the present invention, based on the disclosure herein. Correspondingly, the invention as hereinafter claimed is intended to be broadly construed and interpreted, as including all such variations, modifications and alternative embodiments, within its spirit and scope.

1. A system for leak-testing an article required to be fluid leak-tight in use at a fluid-contacting region thereof, to determine fluid leakage through the article to a potential leak-expression region of the article, said system comprising a leak-testing fluid held in confinement by the fluid-contacting region of the article, a vacuum assembly arranged for establishing a vacuum environment at the potential leak-expression region of the article, and a leak detector arranged to detect presence or absence of the leak-testing fluid in the vacuum environment, to determine fluid leakage through the article, the system including calibration capability for calibrated leak detection.

2.-3. (canceled)

4. The system of claim 1, wherein the article comprises a fluid containment vessel, wherein the fluid containment vessel includes at least one of a joint, seam and coupling, as at least part of said fluid contacting region.

5.-7. (canceled)

8. The system of claim 1, further including a central processor unit coupled to the leak detector and arranged to output results of the leak-testing.

9.-13. (canceled)

14. The system of claim 1, wherein the leak detector has leak detection sensitivity for said leak testing fluid in said vacuum environment that is below 1×10⁻⁷ standard atmospheric-cc/sec.

15. (canceled)

16. The system of claim 4, arranged for contemporaneous leak-testing of multiple fluid containment vessels.

17. The system of claim 1, arranged for successive leak-testing of multiple portions of said article.

18. The system of claim 1, wherein said article comprises a vessel employed for dispensing of fluid, said system comprising an evacuatable chamber adapted to contain said vessel filled with said leak-testing fluid, said vacuum assembly arranged to pump down the evacuatable chamber to establish said vacuum environment therein, and wherein said leak detector is joined in fluid communication with the evacuatable chamber and operative to detect leakage of leak-testing fluid from the vessel into the evacuatable chamber when pumped down by the vacuum assembly, the leak detector including said calibration capability for calibrated leak detection.

19. The system of claim 18, further comprising a fill station for filling the vessel with a leak-testing fluid at superatmospheric pressure.

20. The system of claim 18, wherein the evacuatable chamber is closed by flange assemblies at respective ends thereof, and said flange assemblies comprise removable flanges for accessing interior volume of the evacuatable chamber, wherein the evacuatable chamber and the leak detector are coupled in fluid communication by an elongate conduit therebetween.

21.-23. (canceled)

24. The system of claim 18, wherein the leak detector comprises the vacuum system as an integrated assembly that is constructed and arranged to (i) pump the evacuatable chamber down to vacuum pressure level and (ii) upon achieving a predetermined vacuum pressure in the evacuatable chamber, actuate a leak detection capability of the leak detector.

25. The system of claim 18, further comprising a central processor unit adapted to actuate the leak detector in accordance with a cycle time program in which after a predetermined period of pumping to vacuum level by the vacuum system, the leak detector is actuated to provide an output correlative of presence or absence of the leak-testing fluid.

26. (canceled)

27. The system of claim 18, further including a sealed vessel containing the leak-testing fluid, in the evacuatable chamber, wherein the vessel contains leak-testing fluid at pressure in a range of from 300 to 2000 psig.

28.-31. (canceled)

32. The system of claim 18, wherein the leak detector has leak detection sensitivity under the established vacuum that is below 1×10⁻⁷ standard atmospheric-cc/sec.

33. The system of claim 18, as arranged for contemporaneous leak-testing of multiple vessels, wherein multiple vessels are disposed in selectively evacuatable chambers defining said evacuatable chamber as a multi-chamber array.

34. (canceled)

35. The system of claim 18, further comprising a central processor unit adapted for control of the vacuum assembly and the leak detector, according to a predetermined cycle.

36. The system of claim 1,
comprising an evacuatable chamber adapted to contain the article in an arrangement in which the article confines the leak-testing fluid, with the vacuum assembly being arranged to pump down the evacuatable chamber to establish vacuum therein, and the leak detector being joined in fluid communication with the evacuatable chamber and operative to detect leakage from or through the article of leak-testing fluid into the evacuatable chamber when pumped down by the vacuum assembly, with the leak detector including calibration capability for calibrated leak detection.

37. A method of leak-testing a vessel employed for dispensing of fluid, comprising introducing a leak-testing fluid into the vessel, sealing the leak-testing fluid in the vessel, exposing the sealed vessel to vacuum and measuring leakage of the leak-testing fluid from the vessel, using a self-calibrating leak detector.

38. A method of leak-testing an article required to be fluid leak-tight in use at a fluid-contacting region thereof, to determine fluid leakage through the article to a potential leak-expression region of the article, said method comprising holding a leak-testing fluid in confinement by the fluid-contacting region of the article, establishing a vacuum environment at the potential leak-expression region of the article, and detecting presence or absence of the leak-testing fluid in the vacuum environment, to determine fluid leakage through the article, said method comprising use of a self-calibrating leak detector.

39. The method of claim 38, wherein the article comprises a fluid supply vessel, and the fluid-contacting region of the article comprises a connection, seam and/or wall surface of the fluid supply vessel.

40. (canceled)

41. The system of claim 1, including: a chamber adapted to contain the article in an arrangement in which the article confines a vacuum, and the chamber has the leak-testing fluid introduced therein, so that leak-testing fluid is present in an environment surrounding at least a portion of the article required to be leak-tight in use; the vacuum assembly being arranged to establish vacuum confined by the article; and the leak detector being joined in fluid communication with the vacuum confined by the article and operative to detect leakage of leak-testing fluid into the vacuum confined by the article, said leak detector being self-calibrating and the article comprising a structure selected from among vessels, vessel components and valve structures.

42.-46. (canceled)

47. The system of claim 41, wherein the leak detector has leak detection sensitivity for said leak testing fluid that is below 1×10⁻⁷ standard atmospheric-cc/sec.

48. (canceled)

49. The system of claim 41, arranged for contemporaneous leak-testing of multiple fluid containment vessels.

50. The system of claim 1, wherein said article comprises a vessel employed for dispensing of fluid, and the system includes: a chamber adapted to (i) contain a vessel having vacuum therein, and (ii) have the leak-testing fluid be introduced therein, so that leak-testing fluid is present in an environment surrounding the vessel in the chamber; the vacuum assembly being arranged to establish the vacuum in the vessel; and the leak detector being arranged for fluid communication with the vessel having vacuum therein, and operative to detect leakage of the leak-testing fluid into the vessel, the system including calibration capability for calibrated leak detection.

51. A method of leak-testing a vessel employed for dispensing of fluid, comprising evacuating the vessel to establish vacuum therein, sealing the vessel, exposing the sealed vessel to a leak-testing fluid, and measuring leakage of the leak-testing fluid into the vessel, using a self-calibrating leak detector with a leak detection capability that is below 1×10⁻⁷ standard atmospheric-cc/sec.

52.-54. (canceled)

55. A method of predicting whether a fluid storage and dispensing vessel will leak in future service, comprising leak-testing said vessel prior to placing it in service, to establish whether fluid leakage from said vessel is below 1×10⁻⁸ standard atmospheric-cc/sec.
